(19) United States
(12) Patent Application Publication
(10) Pub. No.: US 2024/0399479 A1
(43) Pub. Date: Dec. 5, 2024

(54) TAP MACHINING METHOD AND TAP MACHINING APPARATUS

(71) Applicant: OKUMA CORPORATION, Niwa-Gun (JP)

(72) Inventor: Kiyoshi YOSHINO, Niwa-Gun (JP)

(73) Assignee: OKUMA CORPORATION, Niwa-Gun (JP)

(21) Appl. No.: 18/663,216

(22) Filed: May 14, 2024

(30) Foreign Application Priority Data
May 31, 2023 (JP) 2023-090387
Aug. 7, 2023 (JP) 2023-128720

(51) Int. Cl. B23G 5/06; B23G 1/18; B23Q 17/00; B23Q 17/09

(52) U.S. Cl. CPC B23G 5/062; B23G 1/18; B23Q 17/0952; B23G 2210/04; B23Q 2017/001

(57) ABSTRACT

A tap machining method includes: forming a female thread by cutting while synchronizing a rotation phase of a main spindle with positions of a workpiece to be machined by the tap and the main spindle in a rotation axis direction of the main spindle, the main spindle rotating while holding a tap with a tool holder mounted on a distal end portion; and adding or subtracting an angle amount of torsional deformation of the tap generated according to a cutting speed to or from the rotation phase of the main spindle during the synchronization.

### CROSS REFERENCE TO RELATED APPLICATION

This application claims the benefit of Japanese Patent Application Number 2023-090387 filed on May 31, 2023 and Japanese Patent Application Number 2023-128720 filed on Aug. 7, 2023, the entirety of which is incorporated by reference.

### FIELD OF THE INVENTION

The disclosure relates to a tap machining method used for tap machining by a machine tool and a tap machining apparatus configured to execute the method.

### BACKGROUND OF THE INVENTION

Tap machining, in which a female thread is formed in a workpiece by an NC machine tool using a tap as a tool for machining female threads, synchronizes a rotation phase of a main spindle with positions of the main spindle and the workpiece in a rotation axis direction of the main spindle to execute the machining. However, cases of tap breakages are often observed when the machining has proceeded to a proximity of a thread bottom. The cause is considered to be insufficient synchronization between the main spindle rotation phase and the positions in the rotation axis direction when the tap is inverted at the thread bottom in order to pull out the tap.

Therefore, for example, JP 2012-011474 A discloses a technique in which a holder that holds a tap is configured to have elasticity by including an elastic body in the holder to absorb insufficiency of the synchronization, thereby preventing breakages.

However, since the method disclosed in JP 2012-011474 A depends on the elastic structure, which is a mechanical factor, degradation in accuracy is concerned when rigidity of the elastic body is changed due to secular change. Additionally, in order to execute the method, the use of a special holder that includes the elastic body is necessary, and there is a need for preparing a different holder for each tap size. Therefore, the method still has problems in ensuring continuous accuracy and versatility.

Therefore, the disclosure has been made in consideration of the above-described problems, and it is an object of the disclosure to provide a tap machining method and a tap machining apparatus configured to machine a female thread with continuously high accuracy while preventing tap breakages as well as having high versatility.

### SUMMARY OF THE INVENTION

In order to achieve the above-described object, a first configuration of this disclosure is a tap machining method. The tap machining method includes: forming a female thread by cutting while synchronizing a rotation phase of a main spindle with positions of a workpiece to be machined by the tap and the main spindle in a rotation axis direction of the main spindle, the main spindle rotating while holding a tap with a tool holder mounted on a distal end portion; and adding or subtracting an angle amount of torsional deformation of the tap generated according to a cutting speed to or from the rotation phase of the main spindle during the synchronization.

In another aspect of the first configuration of this disclosure, which is in the above-described configuration, the angle amount of the torsional deformation of the tap is calculated from a relationship between an angle amount of the torsional deformation of the tap and the cutting speed preliminarily obtained by at least any one of a calculation based on material mechanics, a finite element method, or an actual measurement.

In order to achieve the above-described object, a second configuration of this disclosure is a tap machining apparatus. The tap machining apparatus includes: a machining unit that forms a female thread by cutting while synchronizing a rotation phase of a main spindle with positions of a workpiece to be machined by the tap and the main spindle in a rotation axis direction of the main spindle, the main spindle rotating while holding a tap with a tool holder mounted on a distal end portion; and an adding or subtracting unit that adds or subtract an angle amount of torsional deformation of the tap generated according to a cutting speed to or from the rotation phase of the main spindle during the synchronization.

In another aspect of the second configuration of this disclosure, which is in the above-described configuration, the angle amount of the torsional deformation of the tap is calculated from a relationship between an angle amount of the torsional deformation of the tap and the cutting speed preliminarily obtained by at least any one of a calculation based on material mechanics, a finite element method, or an actual measurement.

The disclosure ensures preventing the tap breakages, not by depending on a mechanical factor, but by a mechanical control, and therefore, ensures forming a female thread with continuously high accuracy. Additionally, a general tool holder without equipping a special design is usable, and therefore, the disclosure provides high versatility.

### BRIEF DESCRIPTION OF THE DRAWINGS

FIG. 1 is a block diagram of a machine tool of Example.

FIG. 2 is an explanatory view illustrating a common tap.

FIG. 3 is an explanatory view illustrating a cutting state by a tap on a cutting cross section of a thread root.

FIG. 4 is a drawing illustrating a cutting cross section of a thread root by an imperfect thread portion on a tap in which a torsional deformation has occurred.

FIG. 5 is a drawing illustrating a cutting cross section of a thread root by a perfect thread portion on a tap in which torsional deformation has occurred.

FIG. 6 is a graph schematically showing a relationship between a cutting speed and an angle amount of torsional deformation of a tap.

### DETAILED DESCRIPTION OF THE INVENTION

The following describes an embodiment of the disclosure based on the drawings.

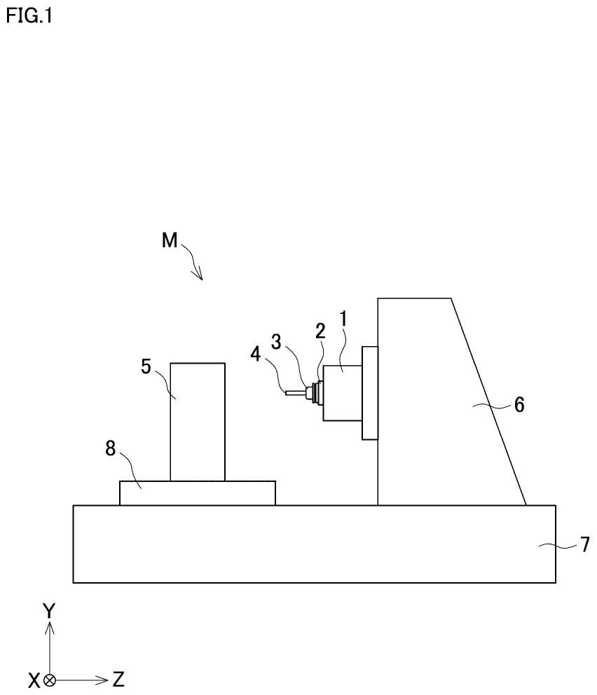

FIG. 1 is a block diagram of a machine tool of Example. In FIG. 1, the depth direction is an X-axis direction, the vertical direction is a Y-axis direction, and the lateral direction is a Z-axis direction. While in the machine tool illustrated in FIG. 1, a cover and other equipment are omitted, the cover and other equipment omitted from the illustration are disposed in practice.

A machining center M as a machine tool configured to operate as a tap machining apparatus includes a bed 7 on which a column 6 movable in the X-axis direction is disposed as illustrated in FIG. 1. A main spindle head 1 movable in the Y-axis direction with respect to the column 6 is also disposed. The main spindle head 1 is equipped with a main spindle 2 rotatable by receiving a power from a main spindle motor, which is not illustrated. The main spindle 2 has a distal end portion to which a tap 4 is attached via a tool holder 3. Meanwhile, the main spindle 2 has a rear end on which a detector, which is not illustrated, that detects a rotation phase of the main spindle 2 is installed. A table 8 movable in the Z-axis direction is disposed on the bed 7, and a workpiece 5 is secured on the table 8. The table 8 moves along the Z-axis by a power of a Z-axis motor, which is not illustrated, and a position in the Z-axis direction is detected by an encoder, which is not illustrated, mounted on the Z-axis motor. Similarly to the table 8, the column 6 and the main spindle head 1 also move along the X-axis and the Y-axis by powers of an X-axis motor and a Y-axis motor, each of which is not illustrated, or by another known power. The respective positions are detected by encoders, which are not illustrated.

The operation of the machining center M is controlled by a control device, which is not illustrated. In addition, the control device stores and processes information obtained by sensors attached to the machining center M, including the detector and the encoder. The control device is configured of a CPU and a memory connected to the CPU, and a predetermined device and the like configured to input and output predetermined information in order to allow various types of processing.

Similarly to the common tap machining described above, also in the tap machining by the machining center M of the disclosure, machining is executed while synchronizing the rotation phase of the main spindle 2 with positions of the main spindle 2 and the workpiece 5 in a rotation axis direction of the main spindle 2. In the disclosure, the rotation axis direction of the main spindle 2 is the Z-axis direction. Accordingly, in the machining center M, the positions of the main spindle 2 and the workpiece 5 in the rotation axis direction of the main spindle 2 are detected as positions in the Z-axis direction of the table 8. During the tap machining, the machining center M is controlled by using the control device, which is not illustrated, such that a value of the detector of the main spindle 2 is synchronized with a position of the table 8, that is, a value of the encoder of the Z-axis motor. Thus, the machining center M forms a female thread in the workpiece 5 by cutting work using the tap 4.

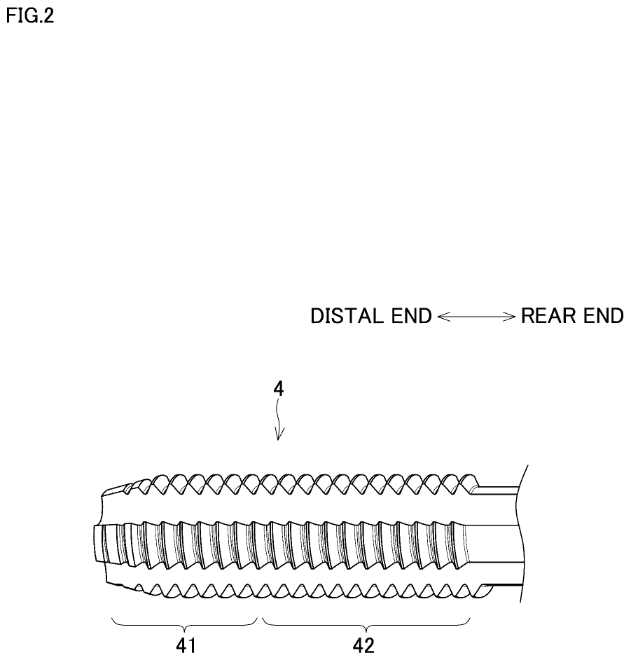

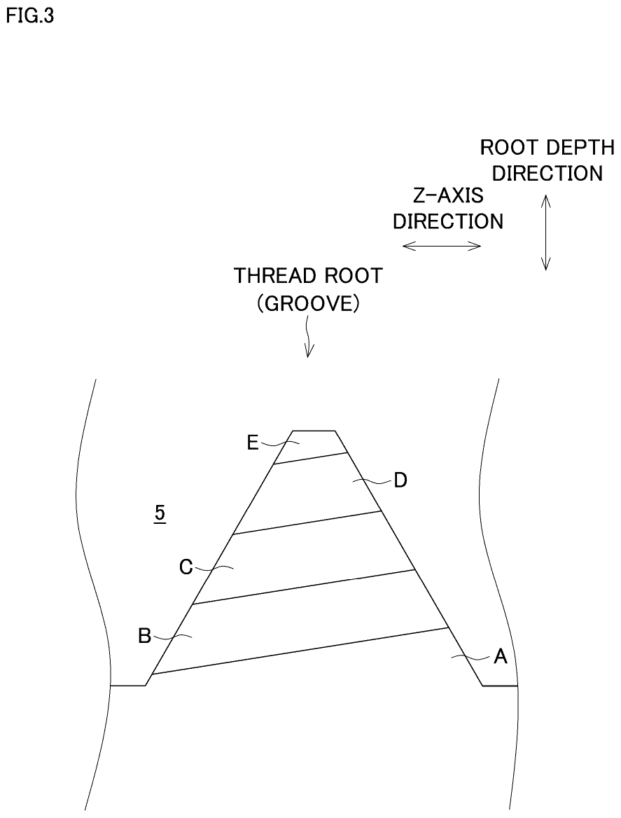

FIG. 2 is an explanatory view illustrating a common tap. FIG. 3 is an explanatory view illustrating a cutting state on a cutting cross section of a thread root.

The tap 4 has a shape similar to that of a common tap. Accordingly, as illustrated in FIG. 2, the tap 4 is provided with a plurality of edges referred also to as ridges at a constant pitch. The tap 4 has a distal end side in which an imperfect thread portion 41 that tapers off is formed. The tap 4 has a rear end side in which a perfect thread portion 42 that has an effective diameter of a desired female thread to be formed by the tap 4 and functions also as a guide is formed. Furthermore, a groove extending parallel to the axial direction is threaded on the tap 4 for discharging swarf of the workpiece 5 during the machining.

During the tap machining of the workpiece 5, as illustrated in FIG. 3, each edge of the imperfect thread portion 41 on the tap 4 cuts a groove that has been shaved by a former edge in the order from A to E such that the thread root gradually deepens.

Here, the principle of tap breakages will be examined.

As described above, in the machining center M, the tap machining is executed while synchronizing the rotation phase of the main spindle 2 with the position in the Z-axis direction of the table 8. As the tap machining progresses, the tap 4 approaches to the thread bottom, and then, the machining center M, while synchronizing the rotation phase of the main spindle 2 with the position in the Z-axis direction of the table 8, lowers the rotation speed of the main spindle 2 and the feed speed of the table 8. At the thread bottom, the rotation speed of the main spindle 2 and the feed speed of the table 8 are 0. Afterwards, while the synchronization between the rotation phase of the main spindle 2 and the position in the Z-axis direction of the table 8 is kept, the rotation direction of the main spindle 2 and the feed direction of the table 8 are inverted to execute the extracting operation of the tap 4.

As already described, the cause of the tap breakage when the tap machining proceeds to the proximity of the thread bottom has conventionally been thought to be the insufficient synchronization between the rotation phase of the main spindle and the positions of the main spindle and the workpiece in the rotation axis direction of the main spindle. The insufficient synchronization is caused by the inverting operation of the tap at the thread bottom for extracting the tap.

Therefore, the applicant has examined the relationship between the rotation phase of the main spindle 2 and the position in the Z-axis direction of the table 8 within a range in the proximity of the thread bottom in which the speed is lowered and the inverting operation is performed in the machining center M. As the result, the values of the detector of the main spindle 2 and the encoder of the Z-axis motor were confirmed to be sufficiently in synchronization. Accordingly, it was found that the breakage principle, which has conventionally been explained that the tap breaks due to the insufficient synchronization between the rotation phase of the main spindle and the positions of the main spindle and the workpiece in the rotation axis direction of the main spindle in the proximity of the thread bottom, failed to explain the tap breakages in the proximity of the thread bottom.

Here, the applicant paid attention to an occurrence of constant torsional deformation in the tap 4 by receiving a cutting resistance of the workpiece 5 during the tap machining at a constant speed. Generally, the cutting resistance is high when the cutting speed is slow, and therefore, when the cutting speed is lowered at the proximity of the thread bottom, the cutting resistance by the workpiece 5 increases to increase a tortional deformation amount of the tap 4. Therefore, the applicant assumed that the cause of the tap breakage at the proximity of the thread bottom might be a change in torsion angle amount of the tap caused by a change in cutting speed.

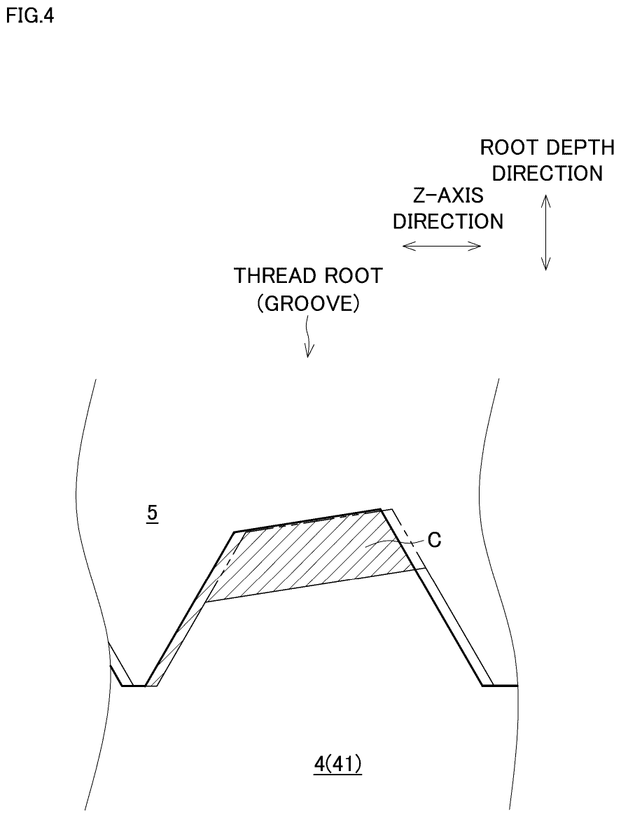

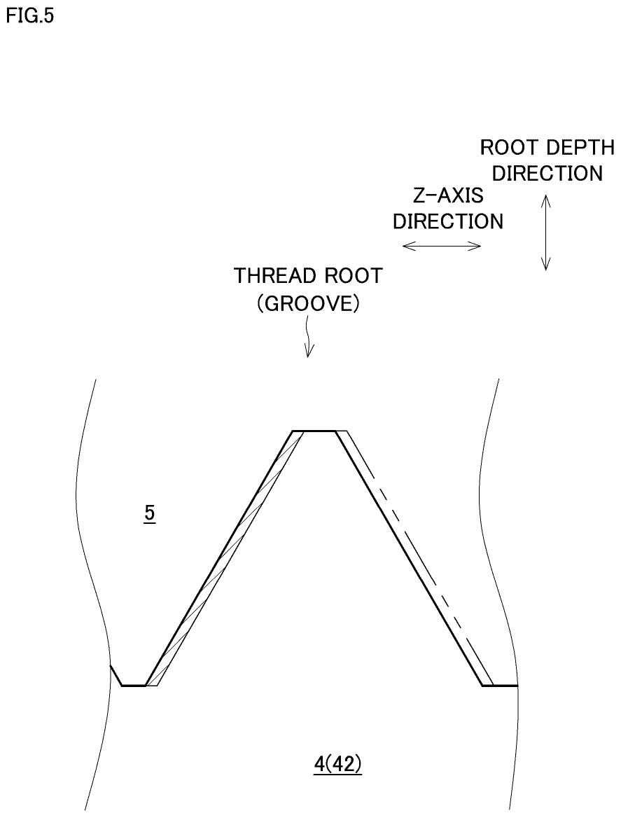

FIG. 4 is a drawing illustrating a cutting cross section of a thread root by the imperfect thread portion 41 on the tap in which torsional deformation has occurred. FIG. 5 is a drawing illustrating a cutting cross section of a thread root by the perfect thread portion 42 on the tap in which torsional deformation has occurred.

As described above, in the tap machining, the tap 4 usually cuts the thread root of the workpiece 5 such that the thread root gradually deepens. However, when the torsional deformation amount of the tap 4 increases, the rotation phase of the main spindle 2 falls into a pseudo delayed state. As the result, even though the synchronization is achieved on the control values of the machining center M, for example, the position in the Z-axis direction of the edge of the tap 4 that is supposed to form the cutting cross section C in FIG. 3 illustrated with a thin line and two-dot chain line in FIG. 4 displaces as illustrated with a bold line in FIG. 4. The displacement of the cutting cross section, that is, the position of the edge of the tap 4 in the Z-axis direction causes the tap 4 to shave a side surface of the thread root, which is a surface in the Z-axis direction of the thread root, in addition to the depth direction of the thread root as illustrated with diagonal lines in FIG. 4. Specifically, the increase in the torsional deformation amount of the tap 4 displaces the positions in the Z-axis direction of the main spindle 2 and the workpiece 5, and thus, a cutting area increases in the imperfect thread portion 41.

The phenomenon of an increased cutting area may occur in all the edges. Due to the increase in torsional deformation amount of the tap 4, the position of the edges of the perfect thread portion 42, usually functioning as a guide at the position illustrated with a two-dot chain line in FIG. 5, is also displaced in the Z-axis direction as illustrated with a bold line in FIG. 5. As the result, the edges of the perfect thread portion 42 serves to cut the side surface of the thread root as illustrated with diagonal lines in FIG. 5.

The increase in cutting area in the Z-axis direction caused as described above increases a cutting load on each edge of the tap 4. The sum of the cutting loads caused by the increase in cutting area generated on each of the edges is added to the cutting load of the tap 4 originally assumed. As the result, it is considered that the tap 4 has an exceeded permissive load to reach the breakage.

Therefore, the disclosure achieves the synchronization of the rotation phase of the main spindle 2 with the position in the Z-axis direction of the table 8 by adding the angle amount of the torsional deformation of the tap 4 that occurs according to the cutting speed to the rotation phase of the main spindle 2. Hereinafter, a specific description will be given.

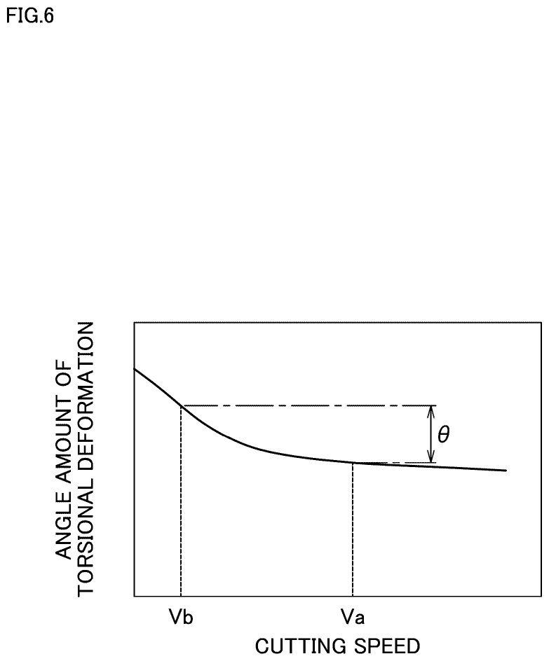

FIG. 6 is a graph schematically illustrating a relationship between the cutting speed and the angle amount of the torsional deformation of the tap.

When the workpiece 5 is tap-machined by the tap 4 using the machining center M, the relationship between the cutting speed and the angle amount of the torsional deformation is preliminarily obtained by at least any one of a calculation based on material mechanics, a finite element method, which is also referred to as FEM, or an actual measurement. As illustrated in FIG. 6, when the cutting speed Va is a reference, an increased amount of the angle amount of the torsional deformation of the tap 4 at the cutting speed Vb is θ. It should be noted that the increased amount θ is uniquely determined by a cutting speed. Accordingly, during the reduction of the rotation speed of the main spindle 2, the increased amount θ constantly changes according to changes in cutting speed.

For example, after the tap machining is performed in a state where the cutting speed is kept constant at the speed Va, the rotation speed of the main spindle 2 and the feed speed of the table 8 are lowered at the proximity of the thread bottom, and when the cutting speed Vb is obtained, the following control is performed. Specifically, the machining center M is controlled such that θ, which is the increased amount of the angle amount of the torsional deformation of the tap 4 when the cutting speed has changed from Va to Vb, is added to the rotation phase of the main spindle 2, and the rotation phase of the main spindle 2, in which the increased amount θ of the angle amount of the torsional deformation of the tap 4 is added, is synchronized with the Z-axis position of the table 8.

Thus, synchronizing the rotation phase of the main spindle 2 added with the increased amount θ of the angle amount of the torsional deformation of the tap 4 with the Z-axis position of the table 8 prevents the position of the cutting cross section in the Z-axis direction from displacing even when the torsional deformation occurs in the tap 4. Specifically, the edges of the tap 4 actually executing the machining are allowed to cut only to deepen the thread root of the workpiece 5 shaved by the former edge. Accordingly, the tap 4 is not added with a load, thereby ensuring the prevention of the breakage of the tap 4. In addition, the disclosure is achievable by the tool holder 3 without the elastic structure as described in JP 2012-011474 A, thereby ensuring machining with high accuracy in a sustained manner. Since the disclosure is achievable by the control of the machining center M, there is no necessity of preparing a special holder for preventing the breakage of the tap 4, thus being high in versatility.

The tap machining method and the machining center M thus configured form a female thread by cutting while synchronizing the rotation phase of the main spindle 2, which rotates while holding the tap 4 with the tool holder 3 mounted on the distal end portion, with the positions of the workpiece 5 to be machined by the tap 4 and the main spindle 2 in the rotation axis direction of the main spindle 2. The angle amount θ of the torsional deformation of the tap 4 generated according to the cutting speed is added to the rotation phase of the main spindle 2 during the synchronization.

Furthermore, the angle amount θ of the torsional deformation of the tap 4 is calculated from the relationship between an angle amount θ of the torsional deformation of the tap 4 and the cutting speed preliminarily obtained by at least any one of the calculation based on material mechanics, a finite element method, or an actual measurement.

Accordingly, the breakage of the tap 4 is preventable not by depending on a mechanical factor, but by a mechanical control, and therefore, a female thread can be formed with continuously high accuracy. The general tool holder 3 without equipping a special design is usable, thereby being high in versatility.

The disclosure has been described above based on the exemplary illustrations, but the technical range thereof is not limited to the above. For example, the tool holder is conveniently selectable from known holders as long as the tap can be held.

The movements of the predetermined configurations in the respective axial directions may be achieved by, for example, configuring the column movable in three axial directions as long as similar movements are possible. Any detector other than the encoder may be used for the detection of the position as well.

Furthermore, regarding the increased amount of the angle amount of the torsional deformation, the cutting speed as a reference is conveniently settable. For example, the state where machining is not performed, that is, the state without torsion with a cutting speed of zero may be set as a reference. Then, the control that adds the increased amount of the angle amount of the torsional deformation may be performed while machining at a constant speed.

In addition, depending on a kind of the workpiece, there are cases where the cutting resistance is reduced in association with the reduction of the cutting speed. In this case, the torsional deformation of the tap reduces when the cutting speed is lowered at the proximity of the thread bottom. Accordingly, when the tap machining of the workpiece as described above is executed, subtracting the decreased amount of the torsional deformation amount from the rotation phase of the main spindle ensures obtaining an effect similar to that of the embodiment.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A tap machining method comprising:
forming a female thread by cutting while synchronizing a rotation phase of a main spindle with positions of a workpiece to be machined by the tap and the main spindle in a rotation axis direction of the main spindle, the main spindle rotating while holding a tap with a tool holder mounted on a distal end portion; and
adding or subtracting an angle amount of torsional deformation of the tap generated according to a cutting speed to or from the rotation phase of the main spindle during the synchronization.

2. The tap machining method according to claim 1, wherein
the angle amount of the torsional deformation of the tap is calculated from a relationship between an angle amount of the torsional deformation of the tap and the cutting speed preliminarily obtained by at least any one of a calculation based on material mechanics, a finite element method, or an actual measurement.

3. A tap machining apparatus comprising:
a machining unit that forms a female thread by cutting while synchronizing a rotation phase of a main spindle with positions of a workpiece to be machined by the tap and the main spindle in a rotation axis direction of the main spindle, the main spindle rotating while holding a tap with a tool holder mounted on a distal end portion; and
an adding or subtracting unit that adds or subtract an angle amount of torsional deformation of the tap generated according to a cutting speed to or from the rotation phase of the main spindle during the synchronization.

4. The tap machining apparatus according to claim 3, wherein
the angle amount of the torsional deformation of the tap is calculated from a relationship between an angle amount of the torsional deformation of the tap and the cutting speed preliminarily obtained by at least any one of a calculation based on material mechanics, a finite element method, or an actual measurement.
